(19) United States
(12) Patent Application Publication
(10) Pub. No.: US 2025/0179392 A1
(43) Pub. Date: Jun. 5, 2025

(54) ANTI-CONTAMINATION AGENT COMPOSITION AND METHOD OF USE

(71) Applicant: ECOLAB USA INC., St. Paul, MN (US)

(72) Inventors: Jia-Yu Wang, Eagan, MN (US); Sugiono Tamsil, Eagan, MN (US); Winai Naewnoingam, Eagan, MN (US); Kasemsak Promchan, Eagan, MN (US)

(21) Appl. No.: 18/949,902

(22) Filed: Nov. 15, 2024

Related U.S. Application Data
(60) Provisional application No. 63/599,539, filed on Nov. 15, 2023.

(51) Int. Cl. C11D 3/382; C11D 1/00; C11D 1/86; C11D 3/37; C11D 17/00

(52) U.S. Cl. CPC C11D 3/382; C11D 1/008; C11D 1/86; C11D 3/37; C11D 17/0043; C11D 2111/12; C11D 2111/20

(57) ABSTRACT

The present disclosure is directed to anti-contamination compositions and the use thereof for preventing pitch or sticky contaminants from deposition on the surface of dryer fabrics and cylinders in the dryer section of paper machines.

### CROSS REFERENCE TO RELATED APPLICATIONS

This application claims priority to U.S. Application No. 63/599,539, filed on Nov. 15, 2023, the contents of which are hereby incorporated by reference in its entirety.

### FIELD OF THE INVENTION

The invention relates to an online dryer cleaning technology to prevent pitch or sticky contaminants from deposition on the surface of fabrics and cylinders in the dryer section of paper machines.

### BACKGROUND

This background information is provided for the purpose of making information believed by the applicant to be of possible relevance to the present invention. No admission is necessarily intended, nor should it be construed, that any of the preceding information constitutes prior art against the present invention. In addition, the preceding information should not be construed to mean that a search has been made or that no other pertinent information as defined in 37 CFR § 1.56 (a) exists.

A papermaking process is to form a paper sheet from an aqueous slurry of pulp with a consistency less than 2%, and chemical additives after water removal. Water removal by itself is comprised of several steps. The first step occurs at the section known as the wet end where water removal is done by gravity and vacuum suction. This gives a continuous mat of intertwined fibers with a consistency of 20% to 25%. As the sheet moves forward, additional water is removed by pressing the wet paper web through press rolls. This increases the sheet consistency to 40% to 50%. Further water removal is done through heating and evaporating in a drying section where the wet paper mat is wound around the surface of a series of steam-heated cylinders (dryers) with a canvas interposed therebetween.

In the above-mentioned drying section, the deposition of pitch or sticky contaminants on the surface of the dryer or the canvas is problematic as the transfer of the contaminants to the paper sheet causes serious deterioration in paper production and sheet quality. To solve this problem, hydrophobic silicone and non-silicone oil-based contamination-preventing agents have been used in treating the surface of dryer cylinders and canvas. U.S. Pat. No. 9,005,394 discloses an application of a blend of amino-modified polysiloxane compound with emulsifiers as an anti-soiling agent for preventing pitch or sticky contaminants from deposition on dyer cylinders, calendar rolls and canvas. U.S. Pat. No. 9,458,572 refines U.S. Pat. No. 9,005,394 by a combined use of modified polysiloxane oil with both high and low molecular weights to address the high-viscosity issue caused by high molecular polysiloxane oil. U.S. Pat. No. 11,214,710 expands the chemistry of modified polysiloxane oil from amino to methylphenyl, polyether, fatty acid ester, epoxy, carboxylic, phenol, mercapto, carbinol, or methacrylic group. US2019/0211504, on the other hand, discloses a contamination-preventing emulsion comprised of a non-silicone oil, a re-transfer agent, and emulsifiers. Nonetheless, all these methods involve the use of a large amount of water and consequently the energy consumption to vaporize water to evenly distribute the anti-contaminant components on the surface of the dryer cylinders and fabrics, which is neither energy efficient nor eco-friendly.

### SUMMARY

The present disclosure provides an online dryer cleaning technology to prevent pitch or sticky contaminants from deposition on the surface of fabrics and cylinders in the dryer section of paper machines. The compositions and the method of use disclosed herein includes non-water containing (water free or substantially free of water) oil-and-surfactant-based components that are highly effective to passivate dryer fabrics and cylinders. When the technology is air-sprayed to the surface of dryer fabrics and cylinders through a specially designed spray system during paper production process, it helps maximize dryer fabrics and cylinders performance by reducing the number of sheet breaks, thus improving machine operation and delivering cost savings.

One aspect of the invention pertains to an anti-contamination composition for preventing pitch or stickiness from deposition on the surface of dryer fabrics and cylinders in the dryer section of paper machines, said anti-contamination composition comprising:
an oil present in a range of about 50% to about 95%, preferably about 75% to about 95%, with more preferably about 85% to 90%, and
one or more surfactants present in a range of about 5% to about 50%, preferably about 5% to about 25%, with more preferably about 10% to about 15%,
wherein said anti-contamination composition is completely free of water or substantially free of water (e.g., less than 5%). In some embodiments, said composition may have HLB range of about 3 to about 14, preferably about 5 to about 13, with more preferably about 7 to about 12.

Another aspect of the invention pertains to a method for preventing pitch or sticky contaminants from deposition in the dryer section of paper machines, said method comprising applying an anti-contamination composition disclosed herein to a surface of said dryer fabrics and cylinders, wherein said anti-contamination composition is air-sprayed to said surface of said dryer fabrics and cylinders without the combined use with a large amount of water.

### DETAILED DESCRIPTION

The buildup of pitch or sticky deposits on the dryer can be challenging in the paper making process for a number of reasons. First, there may be a loss of porosity and drying capacity, resulting in the slowing down of the machine and the consequent reduction in the paper or board production rate. Additionally, there may be a deterioration in quality of the paper sheet. In particular, as the sticky materials “pick” holes in the paper sheet, it results in downstream problems like off-grade finished product or issues in subsequent coating processes. As such, buildup of pitch or sticky materials necessitates the shutdown of the paper machine for cleaning of the fabric and/or replacement. Furthermore, loss of drying capacity results in increased energy consumption as steam utilization is increased to provide additional heat for drying the paper or board. While hydrophobic silicone and non-silicone oil-based contamination-preventing agents have shown effectiveness in treating the surface of dryer cylinders and canvas to prevent pitch or sticky deposition commercially, all these methods involve the use of a large amount of water and consequently the energy consumption to vaporize water to evenly distribute the anti-contaminant components on the surface of the dryer cylinders and fabrics, which is neither energy efficient nor eco-friendly.

The present invention encompasses compositions and the method of use of an anti-contaminant agent that is water free (or substantially free of water). One advantage of the present invention is an online cleaning and passivation technology, thus allowing paper production to continue without interruption. The anti-contaminant compositions are applied in the form of aerosols through the combined use of compressed air, thus eliminating the need for a large quantity of water during application. This differentiates the disclosed invention from other existing technologies on the commercial market. Another advantage of the invention is that it solves dosage limitations on use and compatibility issues with other applied surface chemistries as the current commercially available anti-contamination agent composition itself causes contamination when over dosed, which limits their maximal cleaning power.

One aspect of the invention pertains to an anti-contamination composition for preventing pitch or stickiness from deposition on the surface of dryer fabrics and cylinders in the dryer section of paper machines as disclosed herein, said composition further comprising a formulation aid. As used herein, the term “formulation aid” refers to a composition for promoting formation of a thin layer of non-polar oil on dryer cylinder and canvas surface. Examples of formulation aids that may be used include a fatty acid, a fatty alcohol, a fatty ether, a fatty ester, a triglyceride, a quaternized fatty imidazoline, a non-cyclic quaternized fatty amine, a lipophilic surfactant, or any combination thereof. The formulation aid may also be a wetting agent such as alkoxylated surfactant, betaines, glycinates, sulfosuccinates, sorbitan esters, acetylenic diols and silicone surfactants. Formulation aids such organic quaternary salts having fatty chains of about 12 to about 22 carbon atoms including dialkyl imidazolinium quaternary salts, dialkyl diamidoamine quaternary salts, monoalkyl trimethylammonium quaternary salts, dialkyl dimethylammonium quaternary salts, trialkyl monomethylammonium quaternary salts, ethoxylated quaternary salts, dialkyl and trialkyl ester quaternary salts, and the like, may be used.

### DESCRIPTION OF FIGURES

The patent or application file contains at least one drawing/photograph executed in color. Copies of this patent or patent application publication with color drawing(s) will be provided by the Office upon request and payment of the necessary fee.

FIG. 1. Schematic drawing of the front section of a dryer section using a contamination-preventing agent according to the present invention. FIG. 1 shows the contamination-preventing agent composition used in a dryer section of a paper machine. The front dryer section includes a series of cylindrical dryers #1, #2, #3, #4, #5, #6, and #7 (hereinafter referred to as “#1 to #7”) for heating and drying the wet paper sheet, a series of turning rolls (small grey circle), and a canvas (the thin line connecting the dryer cylinders and turning rolls) for pressing the wet paper sheet against the dryers #1 through #7. In this part of the dryer section, the wet paper sheet is pressed against the surfaces of the dryers #1 to #7 by the canvas. As a result, the wet paper sheet adheres to the dryers #1 to #7 and is simultaneously heated and dried. The contamination-preventing agent composition is imparted to the dryer #1 on the most upstream side of the dryer section at the position of the arrow pointed to dryer #1 (lower left of the FIG. 1) and to the canvas at the position of the arrow pointed to the canvas far right (upper right of the FIG. 1). The method of imparting the contamination-preventing agent composition is not particularly limited, and for example, the position of the dryer cylinder, a spray method using a spray nozzle, or the like are used. At this time, the spray amount of the contamination-preventing agent composition is preferably above 0.5 mg/m2 per passage area of the wet paper. When the spray amount is less than 0.5 mg/m2, the contamination-preventing agent composition does not sufficiently passivate the surface of a dryer. As such, pitch or sticky contaminants cannot be sufficiently prevented. In contrast to hydrophobic silicone-oil based anti-contamination agent, the current invention allows a much wider dosage window to provide effective surface passivation protection without turning the contamination-preventing agent composition itself into contaminants nor negatively impact sheet quality as compared with the case using hydrophobic silicone-oil based compositions.

FIG. 2. Surface cleanliness of dry canvas without (left) and with (right) anti-contamination treatment. The sample of formulation A was sprayed at a rate of 7 ml/min to the canvas at the position of the arrow shown in FIG. 1 on a board machine running a medium grade with a machine speed about 430 m/min. After applying the anti-contamination agent composition for a week, the cleanliness of the dryer canvas was significantly improved comparing to the canvas without the treatment. FIG. 2A. Dryer canvas without anti-contamination treatment. FIG. 2B. Dryer canvas after treatment with Formulation A.

FIG. 3. Surface cleanliness of dry cylinder without (left) and with (right) anti-contamination treatment. FIG. 3A. Dryer cylinder without anti-contamination treatment. FIG. 3B. Dryer cylinder with anti-contamination treatment.

### DEFINITIONS

The following definitions are provided to determine how terms used in this application, in particular, how the claims are to be construed. The organization of the definitions is for convenience only and is not intended to limit any of the definitions to any particular category.

The use of the terms “a” and “an” and “the” and “at least one” and similar referents in the context of describing the invention (especially in the context of the following claims) are to be construed to cover both the singular and the plural, unless otherwise indicated herein or clearly contradicted by context.

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

All methods described herein can be performed in any suitable order unless otherwise indicated herein or otherwise clearly contradicted by context.

As used herein, the term “about” refers to a ±10% variation from the nominal value. It is to be understood that such a variation is always included in any given value provided herein, whether or not it is specifically referred to.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

“Consisting essentially of” means that the methods and compositions may include additional steps, components, ingredients or the like, but only if the additional steps, components and/or ingredients do not materially alter the basic and novel characteristics of the claimed methods and compositions.

The term “viscosity” as used herein refers to the internal friction or molecular attraction of a given material which manifests itself in resistance to flow. It is measured in liquids by standard test procedures and is usually expressed in poise or centipoise (cP) at a specified temperature. As used herein, viscosity is based on measurement at ambient temperature.

As used herein, the term “oil” refers to a non-silicon-based, non-aspiration hazardous, and greasy substance that is chemically inert to other applied paper surface chemistries. The term oil includes mineral oil such as gear oil, dryer oil, turbine oil, spindle oil, liquid paraffin, isoparaffin, naphthene and the like; vegetable oils such as soybean oil, canola oil, sunflower oil, peanut oil, coconut oil, olive oil, palm oil, linseed oil, castor oil, tung oil, tall oil, rapeseed oil, corn oil and the like; synthetic oil such as polyalphaolefin, synthetic ester oil, polyalkylene glycol, synthetic fatty acids and the like. These may be used singly or in combination of two or more.

As used herein, the term “emulsifier surfactant” refers to any surfactant that helps reduce surface tension between oil droplet and air interface. Examples includes one or more surfactants chosen from nonionic surfactants, anionic surfactants, cationic surfactants, amphoteric surfactants, polymeric surfactants, and the like can be used.

As used herein the term, “formulation aid” is used interchangeably “formulation aid composition”, to refer to compositions for promoting a thin layer a of non-polar oil on dryer cylinder and canvas surface. Formulation aids include but not limited to fatty acids, fatty alcohols, fatty ethers, fatty esters, triglycerides, a quaternized fatty imidazoline, a non-cyclic quaternized fatty amine, lipophilic surfactants and the like. These may be used singly or in combination of two or more. Formulation aid can be but not limited to a “wetting agent”.

As used herein, the term “wetting agent” refers to a chemical composition which promotes the spontaneous substrate wetting of hydrophobic oil on the surface of dryer cylinders and fabrics so as to form a very thin, homogeneous layer of oil on these surfaces quickly. One or more formulation aid may be included in the anti-contamination composition to impart improved properties such as instantaneous interaction with the substrate so as to promote the formation of the thin passivation oil layer.

As used herein, the term “substantially free of water” refers to a water content in an amount of less than about 5%, less than about 4%, less than about 3%, less than about 2%, less than about 1%, about 0.01 to about 5%, about 0.01 to about 4%, about 0.01 to about 3%, about 0.01 to about 2%, about 0.01 to about 1%, or about 0.01 to about 0.5%. In some instance, the anti-contamination compositions disclosed herein is “free of water” (i.e., said composition has undetectable amounts of water). Water content may be measured used standard methods such as Gravimetric Method, Karl Fisher Titration, Near-Infrared Spectroscopy, Microwave Moisture Analyzer, Moisture Balance, Infrared Moisture Analyzer, Capacitance and Dielectric Moisture Meters, etc.

As used herein the term “sprayable” refers to a composition that can be sprayed. This includes compositions disclosed herein that has a product viscosity of less than 300 cp, or less than 100 cp, at ambient temperature.

As used herein the term “anti-contamination agent” is used interchangeably with the term “contamination-preventing agent” to refer to a composition for preventing pitch or stickiness from deposition on the surface of dryer fabrics and cylinders in the dryer section of paper machines. In some embodiments, said anti-contamination composition comprises:
an oil present in a range of about 50% to about 95%; and
one or more surfactants present in a range of about 5% to about 50%;
wherein said anti-contamination composition is substantially free of water.

In the event that the above definitions or a description stated elsewhere in this application is inconsistent with a meaning (explicit or implicit) which is commonly used, in a dictionary, or stated in a source incorporated by reference into this application, the application and the claim terms in particular are understood to be construed according to the definition or description in this application, and not according to the common definition, dictionary definition, or the definition that was incorporated by reference. In light of the above, in the event that a term can only be understood if it is construed by a dictionary, if the term is defined by the Kirk-Othmer Encyclopedia of Chemical Technology, 5th Edition, (2005), (Published by Wiley, John & Sons, Inc.) this definition shall control how the term is to be defined in the claims.

One aspect of the invention pertains to an anti-contamination composition for preventing pitch or stickiness from deposition on the surface of dryer fabrics and cylinders in the dryer section of paper machines, said anti-contamination composition comprising:

an oil present in a range of about 50% to about 95%, or about 75% to about 95%, or about 85% to about 90%, and one or more surfactants (e.g., emulsifier surfactant) present in a range of about 5% to about 50%, or about 5% to about 25%, or about 10% to about 15%, wherein said anti-contamination composition is substantially free of water.

In some embodiments, said composition is free of water.

In some embodiments, said emulsifier surfactant comprises a nonionic surfactant, an anionic surfactant, a cationic surfactant, an amphoteric surfactant, a polymeric surfactant, or any combination thereof. In some embodiments, said anti-contamination composition has a HLB range of about 3 to about 14, or about 5 to about 13, or about 7 to about 12.

In some embodiments, said anti-contamination composition is substantially free of water and has a target HLB range of about 3 to about 14, or about 5 to about 13, or about 7 to about 12.

In some embodiments, said composition further comprises a formulation aid that may be present in an amount of above 0.1%, or above 5%, or above 10%. For instance, in certain instances said formulation aid comprises a fatty acid, a fatty alcohol, a fatty ether, a fatty ester, a triglyceride, a quaternized fatty imidazoline, a non-cyclic quaternized fatty amine, a lipophilic surfactant, or any combination thereof.

In some embodiments, a wetting agent may also be used as a formulation ai. The wetting agent may be chosen from alkoxylated surfactants, betaines, glycinates, sulfosuccinates, sorbitan esters, acetylenic diols and silicone surfactants, or a combination thereof.

In some embodiments, the invention encompasses an anti-contamination composition comprising one or more formulation aids. Examples of an anti-contamination formulation may be as below.

TABLE 1
Formulation A

| Chemical description | wt % |
|---|---|
| Alkyloxypolyethyleneoxyethanol | 9.50 |
| Polyethylene Glycol 400 Dioleate | 4.88 |
| Soybean oil | 85.62 |

TABLE 2
Formulation B

| Chemical description | wt % |
|---|---|
| Alkyloxypolyethyleneoxyethanol | 5.5 |
| Polyethylene Glycol 400 Dioleate | 8.88 |
| Mineral oil, naphthenic | 85.70 |

TABLE 3
Formulation C

| Chemical description | wt % |
|---|---|
| White Mineral oil, paraffinic | 85 |
| Tall Oil Fatty Acid | 5 |
| Tween 81 (POE(5) sorbitan monostearate) | 8 |
| Span 80 (Sorbitan monooleate) | 2 |

TABLE 4
Formulation D

| Chemical description | wt % |
|---|---|
| Alkyloxypolyethyleneoxyethanol | 25 |
| Polyethylene Glycol 400 Dioleate | 25 |
| Soybean oil | 50 |

25 parts by mass of alkyloxypolyethyleneoxyethanol (a wetting agent), 25 parts by mass of polyethylene glycol 400 dioleate (emulsifier, non-anionic surfactant) and 50 parts by mass of soybean oil (non-silicone oil) were mixed by stirring to prepare formulation D of a contamination-preventing agent composition.

The HLB of the composition is 10.3 and product viscosity is 64.1 cP at 20° C.

TABLE 5
Formulation E

| Chemical description | wt % |
|---|---|
| Alkyloxypolyethyleneoxyethanol | 25 |
| Soybean oil | 75 |

25 parts by mass of alkyloxypolyethyleneoxyethanol (a wetting agent) and 75 parts by mass of soybean oil (non-silicone oil) were mixed by stirring to prepare formulation E of a contamination-preventing agent composition.

The HLB of the composition is 8.3 and product viscosity is 57.8 cP at 20° C.

TABLE 6
Formulation F

| Chemical description | wt % |
|---|---|
| White Mineral oil, paraffinic | 80 |
| Tall Oil Fatty Acid | 10 |
| Span 80 (Sorbitan monooleate) | 10 |

80 parts by mass of paraffinic oil (non-silicone oil), 10 parts by mass of tall oil fatty acid (formulation aid) and 10 parts by mass of Span 80 (sorbitan monooleate) were mixed by stirring to prepare formulation F of a contamination-preventing agent composition.

HLB of the composition is 4.3 and product viscosity is 35.8 cP at 20° C.

TABLE 7
Formulation G

| Chemical description | wt % |
|---|---|
| Biodiesel | 80 |
| Tall Oil Fatty Acid | 10 |
| Deodol 25-9 (Linear primary | 10 |
| alcohol ethoxylate) | |

80 parts by mass of biodiesel oil (non-silicone oil), 10 parts by mass of tall oil fatty acid (formulation aid) and 10 parts by mass of Deodol 25-9 (linear primary alcohol ethoxylate) were mixed by stirring to prepare formulation G of a contamination-preventing agent composition.

HLB of the composition is 13.1 and product viscosity is 36.7 cP at 20° C.

In some embodiments, said oil is a liquid at room temperature. In further embodiments, said oil may be insoluble in water. The oil used in said composition may be chosen from mineral oil, vegetable oil, and synthetic oil, or any combination thereof. In some instances, a mineral oil chosen from gear oil, dryer oil, turbine oil, spindle oil, liquid paraffin, isoparaffin, and naphthene, or any combination thereof, may be used.

Vegetable oil chosen from soybean oil, canola oil, sunflower oil, peanut oil, coconut oil, olive oil, palm oil, linseed oil, castor oil, tung oil, tall oil, rapeseed oil, and corn oil, or any combination thereof, may be used. It is contemplated that synthetic oil comprising a polyalphaolefin, synthetic ester oil, polyalkylene glycol, and synthetic fatty acid, or any combination thereof, may be used.

In further embodiments, said composition is sprayable (and/or can form aerosol with droplet size of about 10 micrometers to about 100 micrometers).

In some embodiments, said anti-contamination composition is used to improve an online cleaning technology for dryer fabrics and cylinders. Assessment of improvement of said online cleaning technology may be determined for example, by reduced number of sheet breaks per time of machine operation under certain machine speed and visual checked cleanliness of the dryer cylinders and fabrics compared with no treatment by an online anti-contamination composition disclosed herein. This may be done using methods known in the art.

In some embodiments, said anti-contamination composition passivates the surface of dryer fabrics and cylinders. The term “passivate” is known in the paper industry and typically refers to an action to reduce adhesion of pitch or sticky components to the touched surfaces, thus minimizing surface contamination during paper machine operation.

Another aspect of the invention pertains to a method for preventing pitch or sticky contaminants from deposition in the dryer section of paper machines, said method comprising applying an anti-contamination composition disclosed herein to a surface of said dryer fabrics and cylinders, wherein said anti-contamination composition is air-sprayed (at e.g., a pressure of 10 psi to 100 psi) to said surface of said dryer fabrics and cylinders.

In some embodiments, said anti-contamination composition is air-sprayed using air through a spray system during paper production process, wherein air-spraying forms an aerosol, and wherein said spray system comprises an air atomizing nozzle, an air supplying line, and an anti-contamination composition supplying line.

In some embodiments, said air atomizing nozzle mixes air with said anti-contamination composition, and air-sprays said air and said anti-contamination composition mixture to said surface of said dryer fabrics and cylinders.

In some embodiments, said air supplying line comprises an air inlet, an air shut-off valve, an air filter, an air pressure regulator with gauge, and an air flow tube.

In some embodiments, wherein in said anti-contamination composition supplying line comprises a liquid inlet, a liquid shut-off valve, a TW liquid strainer, a liquid pressure regulator with gauge, and a liquid flow tube.

In some embodiments, wherein said air is a compressed air.

In some embodiments, wherein said method reduces the number of sheet breaks, maximizes the performance of dryer fabrics and cylinders, improves machine operations, and delivers cost savings. This may be assessed by methods known in the art which are incorporated by reference.

A non-limiting list of embodiments is provided below:
1. An anti-contamination composition for preventing pitch or stickiness from deposition on the surface of dryer fabrics and cylinders in the dryer section of paper machines, said anti-contamination composition comprising:
   an oil present in a range of about 50% to about 95%; and one or more surfactants present in a range of about 5% to about 50%;
   wherein said anti-contamination composition is substantially free of water.
2. The composition of any of the preceding embodiments, wherein said oil is present in a range of about 75% to about 95%.
3. The composition of any of the preceding embodiments, wherein said oil is present in a range of about 85% to about 90%.
4. The composition of any of the preceding embodiments, wherein said one or more surfactants is present in a range of about 5% to about 25%.
5. The composition of any of the preceding embodiments, wherein said one or more surfactants is present in a range of about 10% to about 15%.
6. The composition of any of the preceding embodiments, wherein said composition is free of water.
7. The composition of any of the preceding embodiments, wherein said anti-contamination composition is substantially free of water and has a target HLB range of about 3 to about 14.
8. The composition of any of the preceding embodiments, wherein said anti-contamination composition is substantially free of water and has a target HLB range of about 5 to about 13.
9. The composition of any of the preceding embodiments, wherein said anti-contamination composition is substantially free of water and has a target HLB range of about 7 to about 12.
10. The composition of any of the preceding embodiments, wherein said composition further comprises a formulation aid.
11. The composition of any of the preceding embodiments, wherein said formulation aid may be present in the amount of above 0.1%, or above 5%, or above 10%.
12. The composition of any of the preceding embodiments, wherein said oil is a liquid at room temperature.
13. The composition of any of the preceding embodiments, wherein said oil is insoluble in water.
14. The composition of any of the preceding embodiments, wherein said composition is sprayable.
15. The composition of any of the preceding embodiments, wherein said composition can form aerosol with droplet sizes of about 10 micrometers to about 100 micrometers.
16. The composition of any of the preceding embodiments, wherein the viscosity is less than about 300 cP.
17. The composition of any of the preceding embodiments, wherein the viscosity is less than about 100 cP.
18. The composition of any of the preceding embodiments, wherein the viscosity in the range of about 30 cP to about 100 cP.
19. The composition of any of the preceding embodiments, wherein said oil is chosen from mineral oil, vegetable oil, and synthetic oil, or any combination thereof.
20. The composition of any of the preceding embodiments, wherein said mineral oil chosen from gear oil, dryer oil, turbine oil, spindle oil, liquid paraffin, isoparaffin, and naphthene, or any combination thereof.
21. The composition of any of the preceding embodiments, wherein said vegetable oil is chosen from soybean oil, canola oil, sunflower oil, peanut oil, coconut oil, olive oil, palm oil, linseed oil, castor oil, tung oil, tall oil, rapeseed oil, and corn oil, or any combination thereof.
22. The composition of any of the preceding embodiments, wherein said synthetic oil comprises a polyalphaolefin, synthetic ester oil, polyalkylene glycol, and synthetic fatty acid, or any combination thereof.
23. The composition of any of the preceding embodiments, wherein said surfactant is an emulsifier surfactant.
24. The composition of any of the preceding embodiments, wherein said emulsifier surfactant comprises a nonionic surfactant, an anionic surfactant, a cationic surfactant, an amphoteric surfactant, a polymeric surfactant, or any combination thereof.
25. The composition of any of the preceding embodiments, wherein said formulation aid comprises a fatty acid, a fatty alcohol, a fatty ether, a fatty ester, a triglyceride, a quaternized fatty imidazoline, a non-cyclic quaternized fatty amine, a lipophilic surfactant, or any combination thereof.
26. The composition of any of the preceding embodiments, wherein said formulation aid is a wetting agent.
27. The composition of any of the preceding embodiments, wherein said wetting agent is chosen from alkoxylated surfactants, betaines, glycinates, sulfosuccinates, sorbitan esters, acetylenic diols and silicone surfactants, or a combination thereof.
28. The composition of any of the preceding embodiments, wherein said anti-contamination composition improves an online cleaning technology for dryer fabrics and cylinders. This may be illustrated by example; reduced number of sheet breaks per time of machine operation under certain machine speed and visual checked cleanliness of the substrate compared with dryer cylinders and fabrics with no treatment by an online anti-contamination composition disclosed herein.
29. The composition of any of the preceding embodiments, wherein said anti-contamination composition passivates the surface of dryer fabrics and cylinders. The term “passivate” is known in the paper industry and typically refers to an action to reduce adhesion of pitch or sticky components to the touched surfaces, thus minimizing surface contamination during paper machine operation.
30. A method for preventing pitch or sticky contaminants from deposition in the dryer section of paper machines, said method comprising applying an anti-contamination composition of embodiment 1 to a surface of said dryer fabrics and cylinders, wherein said anti-contamination composition is air-sprayed (at e.g., a pressure of 10 to 100 psi) to said surface of said dryer fabrics and cylinders.
31. The method of embodiment 33, wherein said composition is air-sprayed at a pressure of about 10 psi to about 100 psi.
32. The method of embodiment 33, wherein said anti-contamination composition is air-sprayed using air through a spray system during paper production process, wherein air-spraying forms an aerosol, and wherein said spray system comprises an air atomizing nozzle, an air supplying line, and an anti-contamination composition supplying line.
33. The method of embodiment 35, wherein said air atomizing nozzle mixes air with said anti-contamination composition, and air-sprays said air and said anti-contamination composition mixture to said surface of said dryer fabrics and cylinders.
34. The method of embodiment 35, wherein said air supplying line comprises an air inlet, an air shut-off valve, an air filter, an air pressure regulator with gauge, and an air flow tube.
35. The method of embodiment 35, wherein in said anti-contamination composition supplying line comprises a liquid inlet, a liquid shut-off valve, a TW liquid strainer, a liquid pressure regulator with gauge, and a liquid flow tube.
36. The method of embodiment 35, wherein said air is a compressed air.

The method of embodiment 33, wherein said method reduces the number of sheet breaks, maximizes dryer fabrics and cylinders performance, improves machine operations, and delivers cost savings.

### EXAMPLES

The foregoing may be better understood by reference to the following examples, which are presented for purposes of illustration and are not intended to limit the scope of the invention.

### Example 1

9.5 parts by mass of alkyloxypolyethyleneoxyethanol (a wetting agent), 4.88 parts by mass of polyethylene glycol 400 dioleate (emulsifier, non-anionic surfactant) and 85.62 parts by mass of soybean oil (non-silicone oil) were mixed by stirring to prepare formulation A of a contamination-preventing agent composition.

The HLB of the composition is 10.9 and product viscosity is 57 cP at 20° C.

### Example 2

5.5 parts by mass of alkyloxypolyethyleneoxyethanol (a wetting agent), 8.8 parts by mass of polyethylene glycol 400 dioleate (emulsifier, non-anionic surfactant) and 562 parts by mass of naphthenic oil (non-silicone oil) were mixed by stirring to prepare formulation B of a contamination-preventing agent composition.

The HLB of the composition is 9.8 and product viscosity is 48 cP @ 20° C.

### Example 3

85 parts by mass of paraffinic oil (non-silicone oil), 5 parts by mass of tall oil fatty acid (formulation aid), 8 parts by mass of POE (5) sorbitan monostearate (emulsifier, non-anionic surfactant) and 2 parts by mass of Span 80 (Sorbitan monooleate) were mixed by stirring to prepare formulation C of a contamination-preventing agent composition.

HLB of the composition is 8.86.

### Example 4

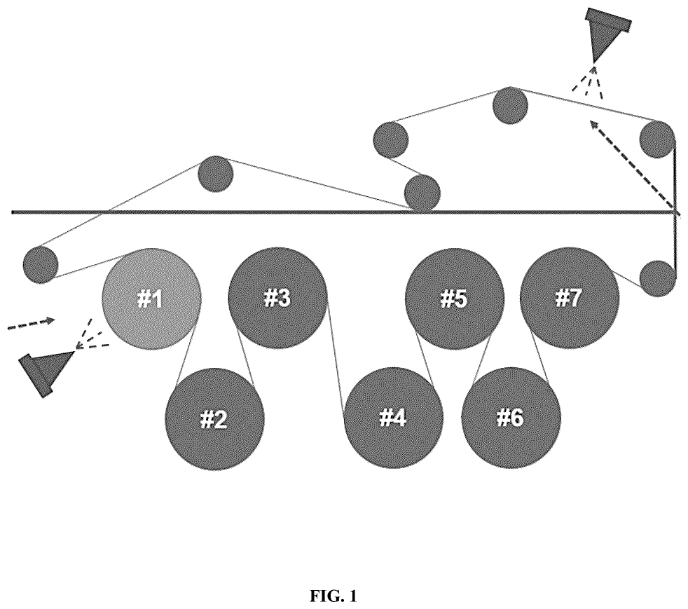

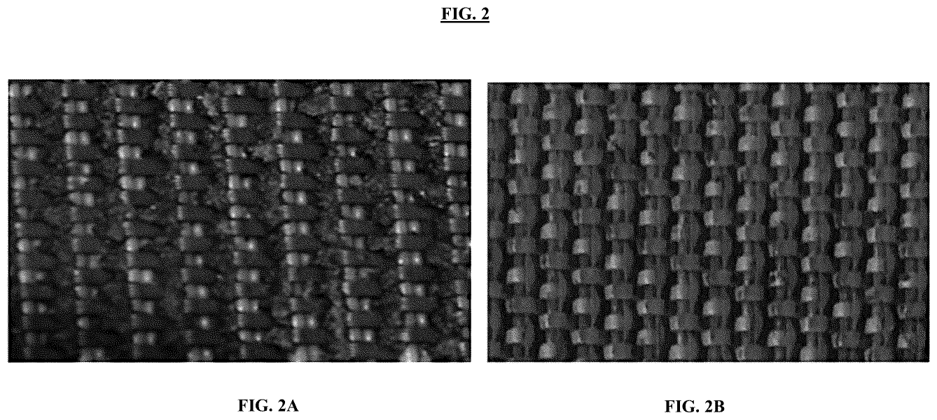

The sample of formulation A was sprayed at a rate of 7 ml/min to the canvas at the position of the arrow shown in FIG. 1 on a board machine running a medium grade with a machine speed about 430 m/min. After applying the anti-contamination agent composition for a week, the cleanliness of the dryer canvas was significantly improved comparing to the canvas without the treatment as shown in FIG. 2.

### Example 5

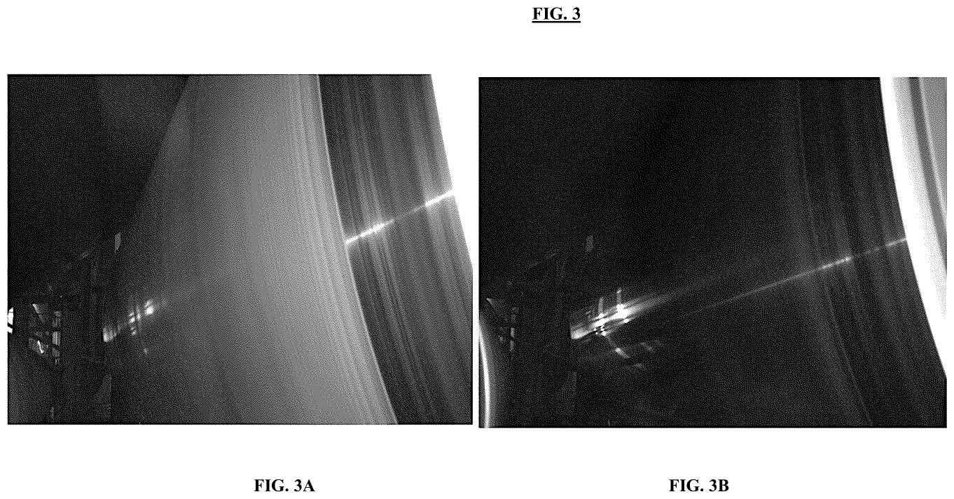

The sample of formulation C1 and C2 was sprayed to the dyer cylinder at the position of the arrow shown in FIG. 1 on a board machine running a medium grade with a machine speed about 830 m/min. C1 has product viscosity of 270 cp and C2 has product viscosity of 45 cp. Because of the higher viscosity of C1, only up to 3 ml/min of C1 can be applied without issue. However, C2 allows a dosage of 12 ml/min. As shown in FIG. 3, after applying the anti-contamination agent composition C2 for four days, the cleanliness of the dryer cylinder was significantly improved comparing to the calendar without the treatment.

### Example 6

Table 8 summarizes the on-machine performance of Formulation A and C when making different paper grades. With the disclosed anti-contamination agents, a significant reduction in sheet breaks due to sticky contaminants was achieved in all paper grades tested, which result in machine efficiency improvement.

TABLE 8
Summary of on-machine performance

| | Reduced | |
|---|---|---|
| | sheet breaks | Machine |
| | comparing | efficiency |
| | to blank | improve |
| Grade | time/Mton | (%) |
| Uncoated free sheet | 72 | 0.45% |
| Newsprint | 480 | 1.80% |
| Liner & Medium | 260 | 0.66% |

All references, including publications, patent applications, and patents, cited herein are hereby incorporated by reference to the same extent as if each reference were individually and specifically indicated to be incorporated by reference and were set forth in its entirety herein.

Embodiments of the present disclosure are described herein, including the best mode known to the inventors for carrying out the invention. Variations of these embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the embodiments appended hereto as permitted by applicable law. Moreover, any combination of the above-described elements in all possible variations thereof is encompassed by the invention unless otherwise indicated herein or otherwise clearly contradicted by context.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments mentioned herein, described herein and/or incorporated herein. In addition the invention encompasses any possible combination that also specifically excludes any one or some of the various embodiments mentioned herein, described herein and/or incorporated herein.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein, then any such conflicting information in such incorporated by reference material is specifically not incorporated by reference herein.

The above disclosure is intended to be illustrative and not exhaustive. This description will suggest many variations and alternatives to one of ordinary skill in this art. All these alternatives and variations are intended to be included within the scope of the embodiments where the term “comprising” means “including, but not limited to”. Those familiar with the art may recognize other equivalents to the specific embodiments described herein which equivalents are also intended to be encompassed by the embodiments.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range. All percentages and proportions herein are by weight unless otherwise specified.

This completes the description of the preferred and alternate embodiments of the invention. Those skilled in the art may recognize other equivalents to the specific embodiment described herein which equivalents are intended to be encompassed by the embodiments attached hereto.

We claim:

1. An anti-contamination composition for preventing pitch or stickiness from deposition on the surface of dryer fabrics and cylinders in the dryer section of paper machines, said anti-contamination composition comprising:
an oil present in a range of about 50% to about 95%, and
one or more surfactants present in a range of about 5% to about 50%, and
wherein said anti-contamination composition is completely free of water or substantially free of water, and
wherein said composition may have a HLB range of about 3 to about 14.

2. The composition of any of the preceding claims, wherein said composition further comprises a formulation aid,
said formulation aid may be present in the range of about 0.1% to about 10%.

3. The composition of any of the preceding claims, wherein said oil is a liquid at room temperature, and said oil is insoluble in water.

4. The composition of any of the preceding claims, wherein said composition is sprayable, wherein said composition can form aerosol with droplet sizes of about 10 micrometers to about 100 micrometers.

5. The composition of any of the preceding claims, wherein the viscosity in the range of about 30 cP to about 100 cP.

6. The composition of any of the preceding claims, wherein said oil is chosen from mineral oil, vegetable oil, and synthetic oil, or any combination thereof.

7. The composition of claim 6, wherein said mineral oil chosen from gear oil, dryer oil, turbine oil, spindle oil, liquid paraffin, isoparaffin, and naphthene, or any combination thereof.

8. The composition of claim 6, wherein said vegetable oil is chosen from soybean oil, canola oil, sunflower oil, peanut oil, coconut oil, olive oil, palm oil, linseed oil, castor oil, tung oil, tall oil, rapeseed oil, and corn oil, or any combination thereof.

9. The composition of claim 6, wherein said synthetic oil comprises a polyalphaolefin, synthetic ester oil, polyalkylene glycol, and synthetic fatty acid, or any combination thereof.

10. The composition of claim 1, wherein said surfactant is an emulsifier surfactant.

11. The composition of claim 10, wherein said emulsifier surfactant comprises a nonionic surfactant, an anionic surfactant, a cationic surfactant, an amphoteric surfactant, a polymeric surfactant, or any combination thereof.

12. The composition of claim 2, wherein said formulation aid comprises a fatty acid, a fatty alcohol, a fatty ether, a fatty ester, a triglyceride, a quaternized fatty imidazoline, a non-cyclic quaternized fatty amine, a lipophilic surfactant, or any combination thereof.

13. The composition of claim 2, wherein said formulation aid is a wetting agent that is chosen from alkoxylated surfactants, betaines, glycinates, sulfosuccinates, sorbitan esters, acetylenic diols and silicone surfactants, or a combination thereof.

14. The composition of any of the preceding claims, wherein said anti-contamination composition actively passivates the surface of dryer fabrics and cylinders thus reducing the deposition of pitch or stickiness from deposition of contaminants on the surface of dryer fabrics and cylinders.

15. The composition of any of the preceding claims, wherein said anti-contamination composition prevents sheet breaks or paper defects in medium grade or liner grade.

16. A method for preventing pitch or sticky contaminants from deposition in the dryer section of paper machines, said method comprising applying an anti-contamination composition of claim 1 to a surface of said dryer fabrics and cylinders,
wherein said anti-contamination composition is air-sprayed at a pressure of about 10 psi to about 100 psi, to said surface of said dryer fabrics and cylinders.

17. The method of claim 16, wherein said anti-contamination composition is air-sprayed using air through a spray system during paper production process,
wherein air-spraying forms an aerosol, and
wherein said spray system comprises an air atomizing nozzle, an air supplying line, and an anti-contamination composition supplying line.

18. The method of claim 17, wherein said air atomizing nozzle mixes air with said anti-contamination composition, and air-sprays said air and said anti-contamination composition mixture to said surface of said dryer fabrics and cylinders.

19. The method of claim 17, wherein said air supplying line comprises an air inlet, an air shut-off valve, an air filter, an air pressure regulator with gauge, and an air flow tube.

20. The method of claim 17, wherein said anti-contamination composition supplying line comprises a liquid inlet, a liquid shut-off valve, a TW liquid strainer, a liquid pressure regulator with gauge, and a liquid flow tube.

21. The method of claim 17, wherein said air is a compressed air.
